(19) United States
(12) Patent Application Publication
(10) Pub. No.: US 2011/0035453 A1
(43) Pub. Date: Feb. 10, 2011

(54) AUTOMATIC RULES-BASED MESSAGING SYSTEM BASED ON ANALYSIS OF TEXT AND/OR ASSOCIATED METADATA

(75) Inventors: Rohit Koul, Jammu and Kashmir (IN); Gurudutta Ramanathaiah, Bangalore (IN); Deepak Ramakrishnan, Bangalore (IN); Vikas Pooven Chathoth, Kerala (IN)

Correspondence Address: Trellis IP Law Group/Oracle, 1900 Embarcadero Road, Suite 109, Palo Alto, CA, 94303, US

(73) Assignee: Oracle International Corporation, Redwood Shores, CA (US)

(21) Appl. No.: 12/537,116

(22) Filed: Aug. 6, 2009

(51) Int. Cl. G06F 15/16

(52) U.S. Cl. 709/206; 709/207

(57) ABSTRACT

In one embodiment, a rule is received that specifies an action to perform based on text of any instant messages received. An input is received to change from a first mode to a second mode. The second mode may be a virtual offline mode in which rules may be applied to incoming instant messages. When an instant message is received, text of the instant message is recognized. For example, text in the body of the instant message or metadata is determined. The rule is applied to the recognized text to determine if an action for the rule should be performed. For example, if a certain phrase is detected, then an action may be performed. The actions may include pre-configured auto-responses, allowing display of the instant message for certain senders even if the user has indicated he/she is busy, or storing of the message for later delivery.

### BACKGROUND

Particular embodiments generally relate to messaging systems.

Instant message systems allow users to set status options, such as busy or away. When a message is received, the sender may be sent a pre-canned busy message. Also, the sent message may be displayed in a popped up instant message window even though they are busy. However, sometimes this message may be lost as the user may not see the message because they are busy. Not receiving a message could cause inconvenience and embarrassment especially in cases where the message was critical. Also, if the message is displayed and a window is popped up, this may distract a user that does not want to be bothered.

Additionally, instant messaging involves many messages in which similar responses are sent. For example, after helping a co-worker with a project, an instant message with the word “thanks” or “thank you” may be received. Typically, a user may respond with “you're welcome” or “no problem.” When a user is involved with many different instant messaging sessions, repetitive typing of these responses may become tedious.

### SUMMARY

Particular embodiments generally relate to applying rules to instant messages.

In one embodiment, a rule is received that specifies an action to perform based on text of any instant messages received. An input is received to change from a first mode to a second mode. The second mode may be a mode (henceforth referred to as virtual offline mode) in which rules may be applied to incoming instant messages. When an instant message is received, text of the instant message is recognized. For example, text in the body of the instant message or metadata is determined. The rule is applied to the recognized text to determine if an action for the rule should be performed. For example, if a certain phrase is detected, then an action may be performed. The actions may include pre-configured auto-responses, allowing display of the instant message for certain senders even if the user has indicated he/she is busy, or storing of the message for later delivery.

In one embodiment, a method is provided comprising: receiving a rule configured to be applied to an instant message, the rule including an action to perform based on text of the instant message; determining an input to change from a first mode to a second mode, the second mode configured to apply the rule on incoming instant messages; receiving an instant message; recognizing text of the received instant message; applying, by a computing device, a condition of the rule to the recognized text of the instant message to determine if the action for the rule should be performed; and performing the action if the condition of the rule is satisfied.

In another embodiment, a computer-readable storage medium comprising encoded logic for execution by the one or more computer processors is provided. The logic when executed is operable to: receive a rule configured to be applied to an instant message, the rule including an action to perform based on text of the instant message; determine an input to change from a first mode to a second mode, the second mode configured to apply the rule on incoming instant messages; receive an instant message; recognize text of the received instant message; apply, by the one or more computer processors, a condition of the rule to the recognized text of the instant message to determine if the action for the rule should be performed; and perform the action if the condition of the rule is satisfied.

In yet another embodiment, an apparatus is provided comprising: one or more computer processors; and logic encoded in one or more computer readable storage media for execution by the one or more computer processors. The logic when executed is operable to: receive a rule configured to be applied to an instant message, the rule including an action to perform based on text of the instant message; determine an input to change from a first mode to a second mode, the second mode configured to apply the rule on incoming instant messages; receive an instant message; recognize text of the received instant message; apply, by the one or more computer processors, a condition of the rule to the recognized text of the instant message to determine if the action for the rule should be performed; and perform the action if the condition of the rule is satisfied.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts an example of a system for applying rules to instant messages according to one embodiment.

FIG. 2 shows a more detailed embodiment of an instant message manager to perform the rules-based actions according to one embodiment.

FIG. 3 depicts different actions that may be performed according to one embodiment.

FIGS. 4A and 4B show a more detailed example of caching of messages for later delivery according to one embodiment.

FIG. 5 depicts a simplified flowchart of a method for applying rules to instant messages according to one embodiment.

### DETAILED DESCRIPTION OF EMBODIMENTS

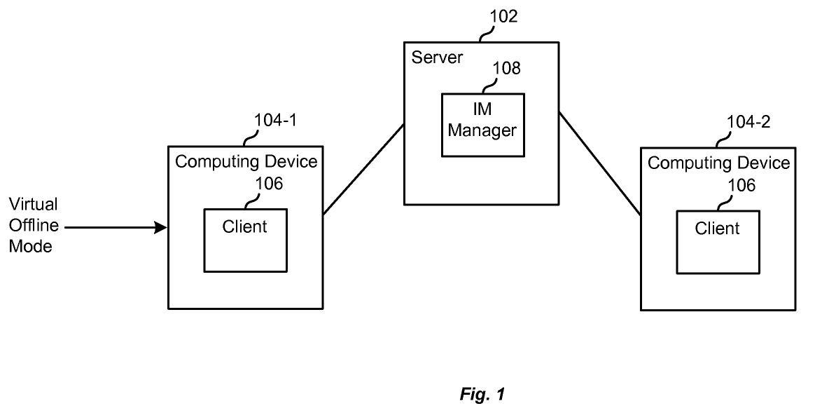

FIG. 1 depicts an example of a system 100 for applying rules to instant messages according to one embodiment. System 100 includes a server 102 and multiple computing devices 104.

Server 102 may be an instant messaging server. For example, server 102 may be a bridge for sending instant messages between various computing devices 104. Server 102 may also include other networking devices that can forward messages, such as routers.

Computing devices 104 may be any computing devices that support messaging. For example, computing devices 104 may include personal computers, cellular phones, smart phones, tablet personal computers, or any other device that supports messaging.

Computing devices 104 may include a messaging client 106. Messaging client 106 may be an instant messaging client. Instant messaging (IM) may be a form of real-time communication between multiple messaging clients 106. Text-based messages or images may be sent using messaging clients 106. The messaging may be referred to as an instant messaging chat. The chat occurs while users are currently logged onto IM client 106 and thus receive the messages in real-time. This may be different from e-mail which may be performed offline. That is, email communication can happen even without the communicating entities being online at the same time Online may be when a user has logged into his/her messaging client using a user ID. When logged on, users may indicate status, which is the state of the user, such as active, busy, do not disturb, or other statuses.

Though two computing devices 104 are shown, it will be understood that server 102 may be servicing multiple computing devices 104. That is, multiple instant messaging sessions may be serviced by server 102. An instant message session may be a chat or may be where two or more users are communicating via instant message. Although not shown, instant messages may be sent over a network, such as the Internet, a cellular network, or a wired network.

Particular embodiments provide a virtual offline mode that allows a user to switch to a mode for instant messaging that uses rules to process instant messages. The virtual offline mode may be different from a first mode, which may be a regular mode of operation. The regular mode of operation may automatically display messages for a user when they are received from another user. The virtual offline mode is a mode that allows processing of text of incoming instant messages to have automatic actions performed.

The virtual offline mode may apply rules to instant messages that are received. The rules may be configured by a user. For example, the rules may allow actions to be performed based on Boolean evaluations of conditions. Users may configure different rules as they desire. These rules may not be pre-determined, such as a pre-determined rule that sets a status as busy and then auto responds with a message that the user is busy when an instant message is received. Rather, the rules may analyze text associated with instant message and perform actions based on the analysis. The text may be found in the body of the instant message (i.e., the message the user typed for another user) or be meta-data describing aspects of the instant message, such as user identification information, system information, or an IP address of the receiver's host for the instant message. The meta-data may also be other information, such as the time the message was sent or header information. Depending on a true/false evaluation of the rules, different actions may be performed.

An instant message manager 108 may apply various actions using rules configured by users. It should be noted that instant message manager 108 is shown in server 102 but can be located in computing device 104 or in other places in the network. Further, it should be noted that functions may be distributed among different devices.

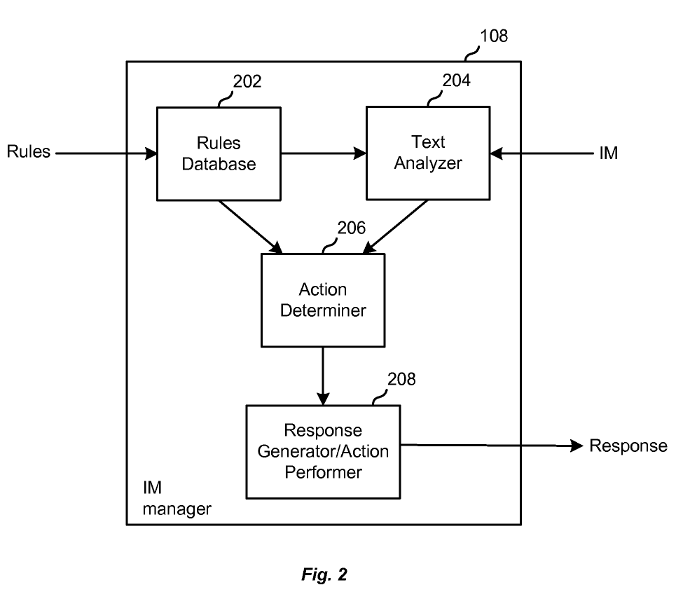

FIG. 2 shows a more detailed embodiment of an instant message manager 108 to perform the rules-based actions according to one embodiment. A rules database 202 may receive rules from a user. A user may configure various rules. The rules may be configured by indicating actions to be performed and specifying conditions that, if evaluated to true, cause the action to be performed. The conditions may indicate text or phrases that, when detected, the action is performed. The rules may be of the form “If <condition>, then perform <action>”. These rules may be stored in rules database 202. In one embodiment, each user of an instant message system may have his/her personal rules stored.

Additionally, rules may be pre-configured. For example, a user may activate certain pre-configured rules. These preconfigured rules may include conditions and actions. The conditions may also include text phrases. In one embodiment, pre-configured rules may be targeted to actions that many users may want performed. For example, responses to common phrases such as “thank you” may be pre-configured in rules. In another embodiment, the pre-configured rules may not be over-ridden by the user and could be activated by default for all users. For example, an action allowing the IM client to display a pop-up irrespective of the mode (Virtual Offline or otherwise) if the sender of the message is the CEO of the company.

The rules may be as detailed as a user desires and may include any number of chained conditions and actions. For example, a chain of conditions may be evaluated to perform an action. The user might want to auto-send a detailed status of the issue he/she is working on if the incoming text of a message includes the words “status of issue 123.” Also, a second condition may be added to determine if the message is sent by a specific user, such as the user's boss. Thus, the status is sent only to the user's Boss. If the same incoming text is sent by the general public, the user may just want to auto-respond with a short note, such as “Busy”. An example rule may be “if user=boss@company.com” and incoming text starts with “status”, auto-response=“boss, I'm currently working on the issue. Will get back to you soon.” Further conditions may be added to this, such as time-based conditions. For example, a time > than 9:00 p.m. may be added and if information detected in the message indicates it is sent after 9:00 p.m., the response may also include “are you still in the office?”

Other rules may be “if user=jen@company.com” and the incoming text includes “thanks,” then auto-response=“no problem.” This may provide an auto-response for frequent responses that are made when an instant message of “thanks” is received. Other examples of rules include “if user=any” and incomingtext=“bye” then auto-response=“bye” or a generic one, “if user=”any” and incomingtext=”*”, then auto-response=”busy”. These rules may be used in both the virtual offline mode and non-virtual offline mode. The virtual offline mode by default could disable a special effects alert, such as the “ping” or “buzz” feature supported by various instant messengers, where the sender instead of sending an instant message, hits a special tab or button on his/her client causing the receivers client shake on the screen and sometimes beep (buzz/ping)

Referring back to FIG. 2, a text analyzer 204 receives an instant message. The text of the instant message may be recognized. For example, a packet may be parsed to determine text of the instant message. The text may include information from the body of the instant message. The text may also include metadata included with the instant message, such as user identification information. The metadata may be included in packets that are used to send the text of the body of the message. The user identification information may be information that identifies the user sending the instant message, such as the user's username, e-mail address, or possibly a workgroup. Other metadata can be detected, such as packet header information, time stamps, etc.

An action determiner 206 then determines an action to be performed based on the text recognized. The conditions in the rules are evaluated based on the text recognized. Actions for conditions that are satisfied are then determined.

A response generator/action performer 208 then performs the action. Different actions may be performed, such as pre-configured auto responses, allowing an instant message to be passed through to a user even though he/she has indicated they are busy, or storing messages for later communication. These actions will be described in more detail below.

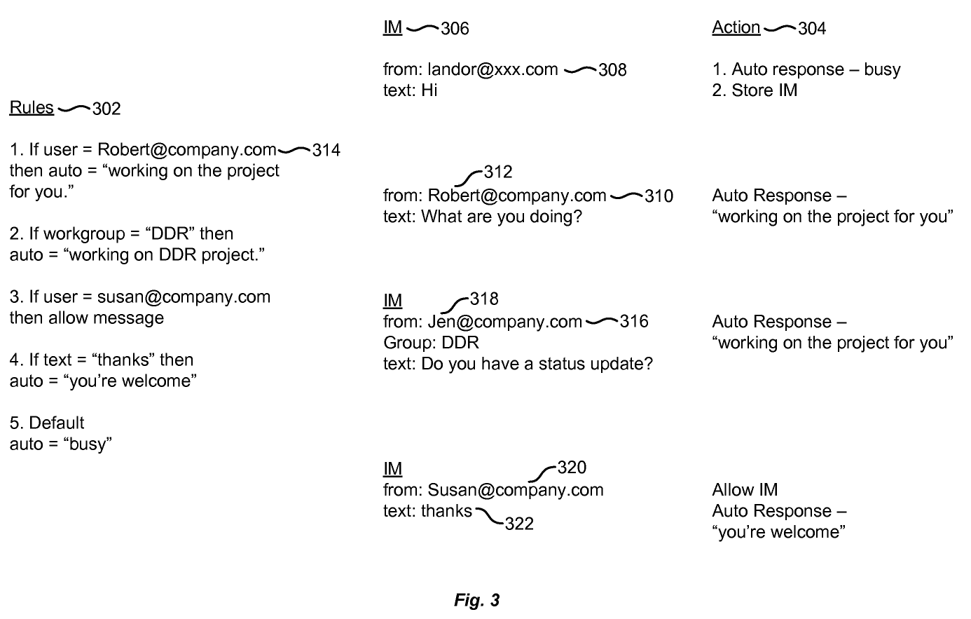

FIG. 3 depicts different actions that may be performed according to one embodiment. Column 302 shows rules that may be applied, column 304 shows actions that may be performed, and column 306 shows instant messages that have been sent. A user may have activated the virtual offline mode in this case. Rules 302 may then be applied to instant messages that are received. A default mode may be performed when no conditions are met for other rules.

At 308, an instant message is received from “landon@xxx.com”. The instant message includes the text of “Hi.” The text found in the message at 308 does not meet any of the conditions of the rules. Accordingly, the default mode (rule 5) may be performed for the virtual offline mode. In this case, an auto-response is sent that indicates the user is busy. Also, the instant message may be stored for later delivery, which will be described in more detail below.

At 310, an instant message may be received from “robert@company.com” with the text of “What are you doing?” The text can be recognized to include identification information 312. In this case, a rule #1 may be applied. Rule #1 indicates that if a user equals “robert@company.com” then an auto-response of “working on the project for you” should be sent. In this case, identification information was recognized from the instant message and an action of sending an auto-response is provided.

At 316, an instant message from “jen@company.com” in a work group of DDR is received. The text of “Do you have a status update?” is also included. Metadata for identification information 318 of jen@company.com does not match any of the condition statements of the rules. However, the identification information includes a work group identifier for the user of DDR. The work group may be any identifier that can be used to classify the user, such as which department the user works in, the company name, or other classifications. The work group matches rule #2. Thus, the auto-response of “working on the DDR project” is sent. Accordingly, the user has set a rule in which different identification information may result in an auto-response.

It is noted that multiple conditions may be satisfied. For example, if the sender of robert company.com was identified in the DDR group, rules #1 and #2 would be satisfied. Different priorities may be assigned to rules to determine which action to take. For example, rule #1 may be selected as the rule to apply.

At 318, an instant message is received from “susan@company.com.” The body text says “thanks.” Metadata of identification information at 320 is susan@company.com and matches a rule #3. In this case, a user may set their default settings to a busy setting. However, the user may actually want to chat with certain senders while in the virtual offline mode. That is, the user may not want to be disturbed by the general public but may want to allow instant messages for certain important people. Rule #3 allows messages for a sender with certain identification information. In this case, the instant message may be displayed.

Also, the body text included at 322 is “thanks” and matches a rule #4. Rule #4 is an auto-response in which text is analyzed in the instant message and an auto-response is provided. The auto-response may be for text that is frequently encountered by the user. For example, the user may receive many instant messages of “thanks” and may usually respond with “you're welcome.” In this case, “you're welcome” is automatically sent. In other embodiments, the user may be prompted and asked to approve the sending of the response of “you're welcome”. In this case, the user may only need to select yes instead of typing the message of “you're welcome”. This saves keystrokes for a user.

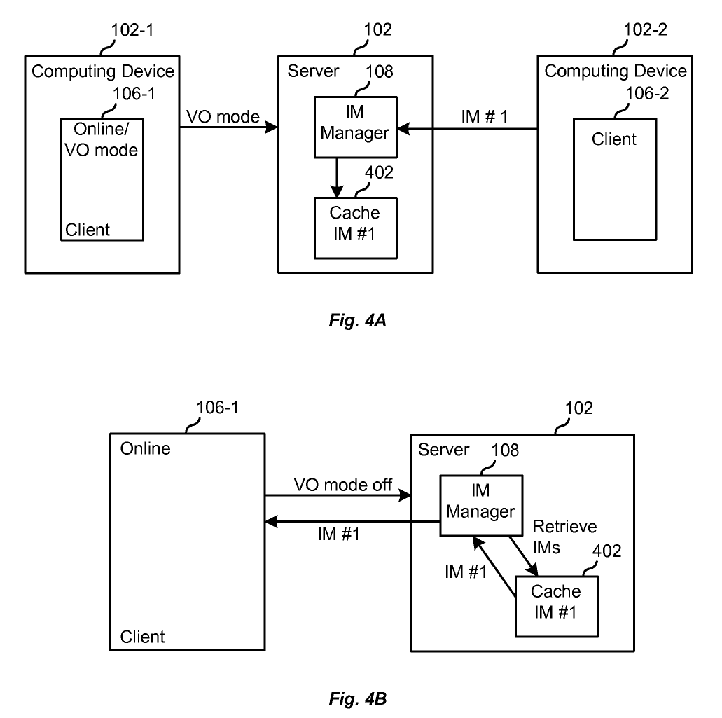

FIGS. 4A and 4B show a more detailed example of the caching of messages for later delivery according to one embodiment. In FIG. 4A, an instant message is sent by messaging client 106-2. Messaging client 106-1 is online but has enabled the virtual offline mode. The user may be logged onto the instant message system but the virtual offline mode is also active. The user may set an option in the virtual offline mode to have messages stored instead of sent to the user. In this mode, the user does not want to receive the instant message immediately. Rather, instant message manager 108 stores the message in storage 402, such as cache or a database. Although the message is shown as being stored in server 102, it will be understood that the message may be stored in other locations, such as computing device 104-1 or another device in the network. The message is stored even though the user is online. It should be noted that this mode may also be used when the user is offline. Further, this mode may be different from storing messages sent when a user is offline and cannot respond. In particular embodiments, a user is online and could respond but has chosen to have the messages stored.

FIG. 4B shows actions taken when the user turns the virtual offline mode off according to one embodiment. IM client 106-1 is also still in the online mode. When this occurs, IM manager 108 detects the virtual offline mode being turned off and retrieves instant messages from storage 402. For example, instant message #1 is retrieved and sent to IM client 106-1.

This mode allows users to avoid receiving pop-ups and messages when the user is busy. For example, the user may not want to be disturbed with instant messages that are received. This includes sounds that are played when instant messages are received or pop-up windows. In this way, the messages are stored for later delivery when the virtual offline mode is turned off. It should be noted that the user may not turn the virtual offline mode totally off but may disable a rule that is used to specify the storing of instant messages to actually receive the messages.

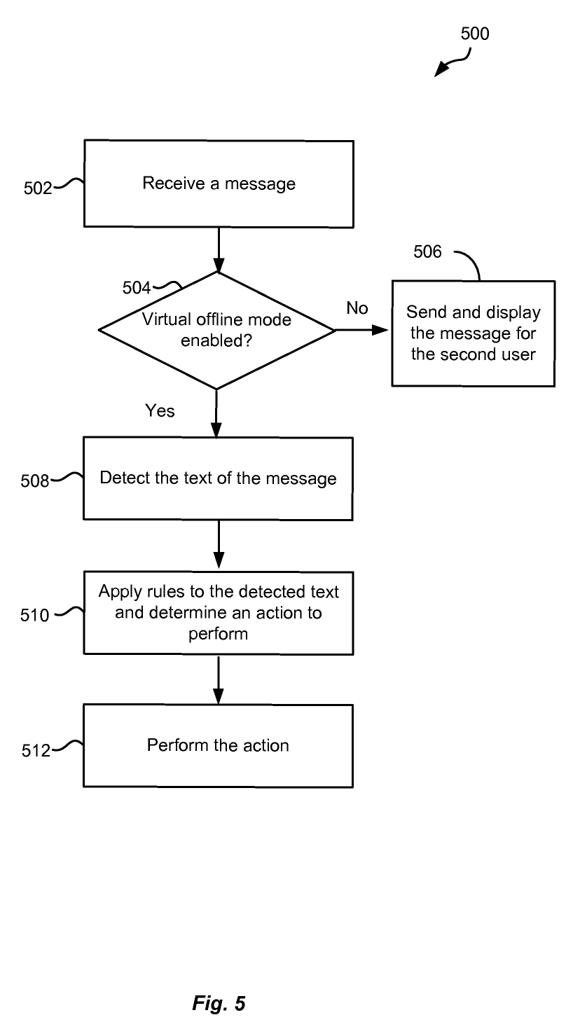

FIG. 5 depicts a simplified flowchart 500 of a method for applying rules to instant messages according to one embodiment. The method may be performed by computing device 104-1 and/or server 102.

Step 502 receives a message. For example, a first user may send an instant message to a second user.

Step 504 determines if user #2 has enabled the virtual online mode. If not, step 506 sends and displays the message for the second user. This may be the regular operation of instant messaging systems.

If the virtual offline mode is on, step 508 detects the text of the message. The text that may be determined may include the body of the message in addition to any metadata.

Step 510 applies rules to the detected text and determines an action to perform. For example, conditional statements may be analyzed to determine actions to perform. Step 512 then performs the action.

Different examples will now be described. It will be understood that other examples may be appreciated. A first example involves pre-configured auto responses. When a user switches to the virtual offline mode, a prompt may be displayed to enter a description/reason for being in the mode. The user could either type in the description/reason or in certain embodiments, choose from system-generated pre-populated templates/user-generated last few (e.g., 10) reasons. For example, the user may be busy. The presence of the user may also be changed to busy and is propagated to any other user that includes the user as a friend or is instant messaging with the user. The description may be configured to be applied to various users or groups using rules. For example, Robert may be busy de-bugging a major customer problem at work. Some co-workers in the user's workgroup may want to know the status of the defect he is working on but he is too busy de-bugging the issue. Robert may enable the virtual offline mode where co-workers in his workgroup may receive an instant message auto-response that he cannot chat because he is working on de-bugging a problem. This message may be sent whenever an instant message is received from his group. Also, specific rules may be tailored on a per-user basis. For example, a more detailed response may be sent to Robert's boss if an instant message is received from the boss. Also, a simple default message may be sent, such as “busy, will get back to you” for people not involved with his immediate workgroup.

Another example may be to allow exceptions for users while in the virtual offline mode. When the virtual offline mode is set, Robert may actually want to chat with certain users while the virtual offline mode is enabled. For example, Robert may not want to be disturbed by the general public but may be expecting a message from his boss, who could provide valuable input on the customer issue Robert is working on. Robert may thus configure a rule that allows specific users to bypass the virtual offline mode. In this case, an instant message from the boss will be sent to Robert but instant messages from the general public will not be sent and may receive a specific auto-response. In another example, Robert may not know the exact user who has been designated to send him the critical updates but may know the group (say DEV) he/she belongs to. Robert may thus configure a role to allow users belonging to group DEV to bypass the virtual offline mode.

In one embodiment, the presence for Robert as seen by a specific user such as the boss may be active instead of busy when the boss is included in a rule as an exception to the virtual offline mode. In this case, the boss will see Robert as being active online and thus assumes that he/she can send a message to Robert. If the status is set as busy, a user seeing that status may be discouraged from sending an instant message because he/she does not want to disturb Robert. Accordingly, changing the presence based on rules may be helpful in that important messages are not held back from key users.

Particular embodiments may be extended to any communication modalities, such as e-mails, voicemails, or mobile phones. For example, when walking into a presentation, a user does not need to switch off his/her cell phone or put it into silent mode. Rather, the virtual offline mode may be switched on and can respond to SMS and/or incoming calls with pre-determined messages. For example, every message that is received may receive an auto-response. The response may be “The user is busy and in a presentation.” At a later time, the SMS may be sent to the user when the virtual offline mode is disabled.

Particular embodiments provide many advantages. For example, configurable, rule-based auto-responses are enabled. The virtual offline mode is effective in not allowing any potential distractions, dips in productivity due to unwanted communications, and potentially embarrassing situations when a user is online but actually “busy.” The use of the rules is powerful and the analysis of text in the instant messages allows users to provide more detailed actions to be performed. Additionally, the auto-responses may cut down on repetitive typing.

Although the description has been described with respect to particular embodiments thereof, these particular embodiments are merely illustrative, and not restrictive. Although instant messaging is described, it will be understood that other modalities, such as cellular and voice calls, may use particular embodiments.

Any suitable programming language can be used to implement the routines of particular embodiments including C, C++, Java, assembly language, etc. Different programming techniques can be employed such as procedural or object oriented. The routines can execute on a single processing device or multiple computer processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method comprising:
receiving a rule configured to be applied to an instant message, the rule including an action to perform based on text of the instant message;
determining an input to change from a first mode to a second mode, the second mode configured to apply the rule on incoming instant messages;
receiving an instant message;
recognizing text of the received instant message;
applying, by a computing device, a condition of the rule to the recognized text of the instant message to determine if the action for the rule should be performed; and
performing the action if the condition of the rule is satisfied.

2. The method of claim 1, wherein the condition specifies text and an action to perform when the text is recognized in an instant message.

3. The method of claim 1, wherein the action comprises an auto-response, the method further comprising sending an auto-response when the text is recognized.

4. The method of claim 3, wherein the condition of the rule comprises a user identifier or a user work group, wherein the auto-response is sent when the recognized text includes the user identifier or the user work group.

5. The method of claim 1, wherein the second mode is configured to send a message indicating the user is busy except when the rule specified that the message is to be sent to the user when the condition is satisfied.

6. The method of claim 5, wherein the recognized text of the instant message includes a user identifier specified by the condition, wherein the message is sent to the user when the user identifier is recognized in the instant message.

7. The method of claim 1, wherein the message is stored when the action does not display the message to the user upon receipt, the method further comprising:
receiving the message upon a change from the second mode to the first mode.

8. The method of claim 1, wherein the recognized text of the instant message is found in a body of the instant message or metadata of the instant message.

9. The method of claim 1, wherein the second mode changes presence seen by other users to a non-active status.

10. The method of claim a, wherein the rule specifies that a second user sees an active status for the user even if the user has indicated the user's status is non-active.

11. A computer-readable storage medium comprising encoded logic for execution by the one or more computer processors, the logic when executed is operable to:
receive a rule configured to be applied to an instant message, the rule including an action to perform based on text of the instant message;
determine an input to change from a first mode to a second mode, the second mode configured to apply the rule on incoming instant messages;
receive an instant message;
recognize text of the received instant message;
apply, by the one or more computer processors, a condition of the rule to the recognized text of the instant message to determine if the action for the rule should be performed; and
perform the action if the condition of the rule is satisfied.

12. The computer-readable storage medium of claim 11, wherein the condition specifies text and an action to perform when the text is recognized in an instant message.

13. The computer-readable storage medium of claim 11, wherein the action comprises an auto-response, the method further comprising sending an auto-response when the text is recognized.

14. The computer-readable storage medium of claim 13, wherein the condition of the rule comprises a user identifier or a user work group, wherein the auto-response is sent when the recognized text includes the user identifier or the user work group.

15. The computer-readable storage medium of claim 11, wherein the second mode is configured to send a message indicating the user is busy except when the rule specified that the message is to be sent to the user when the condition is satisfied.

16. The computer-readable storage medium of claim 15, wherein the recognized text of the instant message includes a user identifier specified by the condition, wherein the message is sent to the user when the user identifier is recognized in the instant message.

17. The computer-readable storage medium of claim 11, wherein the message is stored when the action does not display the message to the user upon receipt, the method further comprising:
receiving the message upon a change from the second mode to the first mode.

18. The computer-readable storage medium of claim 11, wherein the recognized text of the instant message is found in a body of the instant message or metadata of the instant message.

19. The computer-readable storage medium of claim 11, wherein the second mode changes presence seen by other users to a non-active status.

20. An apparatus comprising:
one or more computer processors; and
logic encoded in one or more computer readable storage media for execution by the one or more computer processors and when executed operable to:
receive a rule configured to be applied to an instant message, the rule including an action to perform based on text of the instant message;
determine an input to change from a first mode to a second mode, the second mode configured to apply the rule on incoming instant messages;
receive an instant message;
recognize text of the received instant message;
apply, by the one or more computer processors, a condition of the rule to the recognized text of the instant message to determine if the action for the rule should be performed; and
perform the action if the condition of the rule is satisfied.
